(19) United States
(12) Patent Application Publication
(10) Pub. No.: US 2018/0217921 A1
(43) Pub. Date: Aug. 2, 2018

(54) SYSTEM AND METHOD FOR GENERATING AND EXECUTING AUTOMATED TEST CASES

(71) Applicant: Cognizant Technology Solutions India Pvt. Ltd., Chennai (IN)

(72) Inventors: Vrushal Palyekar, Pune (IN); Dipak Mahajan, Pune (IN); Pramod Londhe, Dist - Hingoli (IN); Bipin Srivastava, Pune (IN); Shrirang Kulkarni, Pune (IN)

(21) Appl. No.: 15/700,435

(22) Filed: Sep. 11, 2017

(30) Foreign Application Priority Data
Feb. 2, 2017 (IN) 201741003898

(51) Int. Cl. G06F 11/36

(52) U.S. Cl. CPC G06F 11/3684; G06F 11/3692; G06F 11/3676; G06F 11/3688

(57) ABSTRACT

A system, computer-implemented method and computer program product for generating and executing test cases is provided. The system comprises a configuration unit configured to receive test data corresponding to one or more test cases and link the received test data to one or more test scripts. The system further comprises an execution unit configured to execute the one or more test cases by invoking an enterprise system comprising an application to be tested and executing the linked test scripts for testing the application, wherein the enterprise system is invoked automatically via an intermediary unit. Furthermore, the system comprises a reporting module configured to generate one or more reports corresponding to the executed one or more test cases.

### CROSS REFERENCE TO RELATED APPLICATION

This application is related to and claims the benefit of Indian Patent Application No. 201741003898 filed on Feb. 2, 2017, the contents of which are herein incorporated by reference in their entirety.

### FIELD OF THE INVENTION

The present invention relates generally to automated testing. In particular, the present invention relates to a system and method for effectively generating and executing automated test cases for testing.

### BACKGROUND OF THE INVENTION

A hardware/software system which is in development stage undergoes testing procedures to verify if performance of the hardware/software system is as per the intended functionalities. With an ever increasing demand for application features, enterprise systems are integrated with multiple software applications. Due to huge number of integrated software applications, a need for efficient testing is continuously increasing, more so as the integrated software applications generally have multiple versions and varied functionalities.

Conventional testing approaches generally involve high costs and require skilled resources with knowledge of high-level scripting and programming languages. Additionally, with increasing number of testing functionalities, for example in the case of regression testing, more and more test cases are required which involves higher costs.

In light of the above, there is a need for a system and method that optimizes execution of test cases and test scripts. Further, there is a need for a testing tool which facilitates testing of software application functions by users with minimal programming and scripting skills.

### SUMMARY OF THE INVENTION

A system, computer-implemented method and computer program product for generating and executing test cases is provided. The system comprises a configuration unit configured to receive test data corresponding to one or more test cases and link the received test data to one or more test scripts. The system further comprises an execution unit configured to execute the one or more test cases by invoking an enterprise system comprising an application to be tested and execute the linked test scripts for testing the application, wherein the enterprise system is invoked automatically via an intermediary unit. Furthermore, the system comprises a reporting module configured to generate one or more reports corresponding to the executed one or more test cases.

In an embodiment of the present invention, the one or more test cases are created by providing parametric details for creation, execution, and generation of reports corresponding to the one or more test cases. In an embodiment of the present invention, the parametric details comprise information related to testing project, application, test steps, priority and execution. In an embodiment of the present invention, the received test data corresponding to the one or more test cases is used for execution of the one or more test cases. In an embodiment of the present invention, the one or more test scripts are one or more functions that on execution facilitate performing one or more actions related to the one or more test cases to test specific functionality of the application under test.

In an embodiment of the present invention, the intermediary unit facilitates invoking the enterprise system by converting information required for testing into one or more message formats that are compatible with the enterprise system. In an embodiment of the present invention, the reporting module is further configured to facilitate forwarding the one or more reports to a desired location via one or more communication channels. In an embodiment of the present invention, the one or more communication channels comprise Electronic Mail (Email), facsimile, Short Messaging Service (SMS) and instant messengers.

The computer-implemented method for generating and executing test cases, via program instructions stored in a memory and executed by a processor, comprises receiving test data corresponding to one or more test cases. The computer-implemented method further comprises linking the received test data to one or more test scripts. Furthermore, the computer-implemented method comprises executing the one or more test cases by invoking an enterprise system comprising an application to be tested and executing the linked test scripts for testing the application, wherein the enterprise system is invoked automatically via an intermediary unit. The computer-implemented method also comprises generating one or more reports corresponding to the executed one or more test cases.

The computer program product for generating and executing test cases comprises a non-transitory computer-readable medium having computer-readable program code stored thereon, the computer-readable program code comprising instructions that when executed by a processor, cause the processor to receive test data corresponding to one or more test cases. The processor further links the received test data to one or more test scripts. Furthermore, the processor executes the one or more test cases by invoking an enterprise system comprising an application to be tested and executing the linked test scripts for testing the application, wherein the enterprise system is invoked automatically via an intermediary unit. The processor also generates one or more reports corresponding to the executed one or more test cases.

### BRIEF DESCRIPTION OF THE ACCOMPANYING DRAWINGS

The present invention is described by way of embodiments illustrated in the accompanying drawings wherein:

FIG. 1 is a block diagram illustrating a system for generating and executing automated test cases, in accordance with an embodiment of the present invention;

FIG. 1A, 1B and 1C illustrate an exemplary user interface to create new projects and add one or more users to the created projects, in accordance with an embodiment of the present invention;

FIG. 1D illustrate a user interface for adding new applications and corresponding versions or fields to the testing unit, in accordance with an exemplary embodiment of the present invention;

FIG. 1Ei illustrate a user interface for creating a new user profile and editing existing user profiles, in accordance with an exemplary embodiment of the present invention;

FIG. 1Eii illustrate a user interface for creating a new user and selecting role of the new user, in accordance with an exemplary embodiment of the present invention;

FIG. 1F is a user interface illustrating ‘test manager’ tab used for creating a folder for new project, in accordance with an exemplary embodiment of the present invention;

FIG. 1G illustrates a user interface depicting a “create test job” function, in accordance with an exemplary embodiment of the present invention;

FIG. 1H illustrates a user interface for creating a new test case, in accordance with an exemplary embodiment of the present invention;

FIG. 1Ii illustrates a user interface depicting a “create test step” option for creating test steps via the testing unit, in accordance with an exemplary embodiment of the present invention;

FIG. 1Iii illustrates a user interface for providing details corresponding to a new test step, in accordance with an exemplary embodiment of the present invention;

FIG. 1J illustrates a user interface for providing test data, in accordance with an exemplary embodiment of the present invention;

FIG. 1K illustrates an exemplary user interface for linking existing test data to a new test step, in accordance with an embodiment of the present invention;

FIG. 1L illustrates a user interface for creating functions provided by the testing unit, in accordance with an exemplary embodiment of the present invention;

FIG. 1M illustrates a user interface for setting static values for an ‘addDays’ function, in accordance with an exemplary embodiment of the present invention;

FIG. 1N illustrates a user interface for configuring variables for account creation using a “copy” function, in accordance with an exemplary embodiment of the present invention;

FIG. 1O illustrates a user interface depicting a validation function, in accordance with an exemplary embodiment of the present invention;

FIG. 1P illustrates a user interface depicting an “execution history” option, in accordance with an exemplary embodiment of the present invention;

FIG. 1Q illustrates a user interface depicting status of all test steps in a specific run from “execution history”, in accordance with an exemplary embodiment of the present invention;

FIG. 1R illustrates a user interface depicting a configuration management option for facilitating access to an enterprise system, in accordance with an exemplary embodiment of the present invention;

FIG. 1S illustrates a user interface depicting an “execute folder” option, in accordance with an exemplary embodiment of the present invention;

FIG. 1T illustrates a user interface for viewing test execution reports, in accordance with an exemplary embodiment of the present invention;

FIG. 1U illustrates a test execution report in an HTML format, in accordance with an exemplary embodiment of the present invention;

FIG. 1V illustrates a user interface for creating a rule for test script verification, in accordance with an exemplary embodiment of the present invention;

FIG. 2 is a flowchart illustrating a method for generating and executing automated test cases, in accordance with an embodiment of the present invention; and

FIG. 3 illustrates an exemplary computer system for generating and executing automated test cases, in accordance with various embodiments of the present invention.

### DETAILED DESCRIPTION OF THE INVENTION

A system and method for generating and executing automated test cases effectively is described herein. In particular, the invention provides for a system which facilitates generating automated test cases for testing of software application functionalities. Further, the invention provides for a system that is capable of communicating with a backend enterprise system for executing test cases optimally.

The following disclosure is provided in order to enable a person having ordinary skill in the art to practice the invention. Exemplary embodiments are provided only for illustrative purposes and various modifications will be readily apparent to persons skilled in the art. The general principles defined herein may be applied to other embodiments and applications without departing from the spirit and scope of the invention. Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

The present invention would now be discussed in context of embodiments as illustrated in the accompanying drawings.

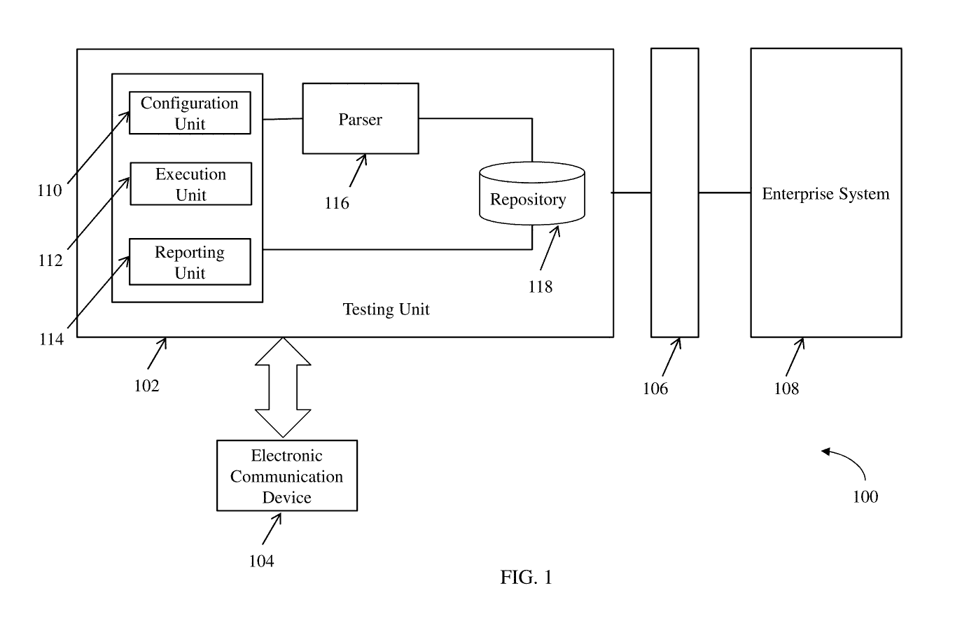

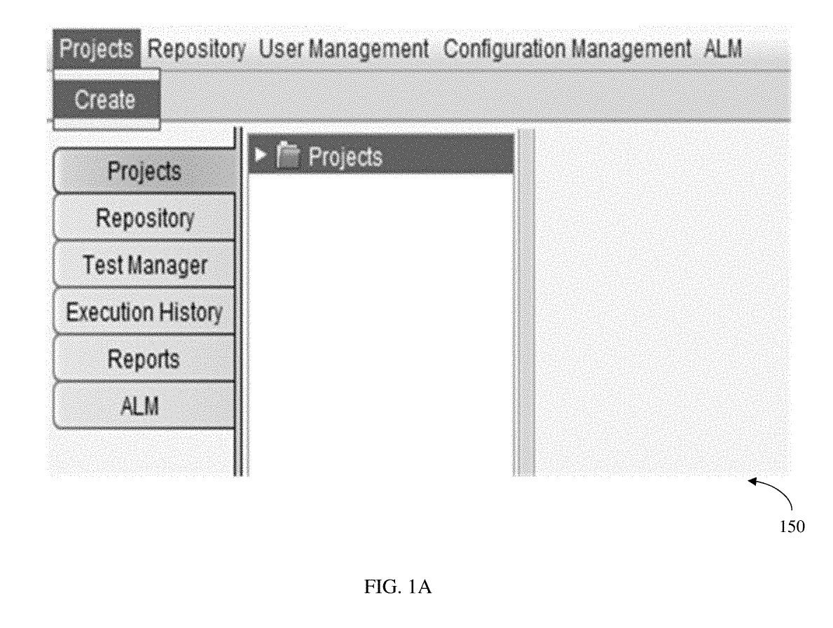

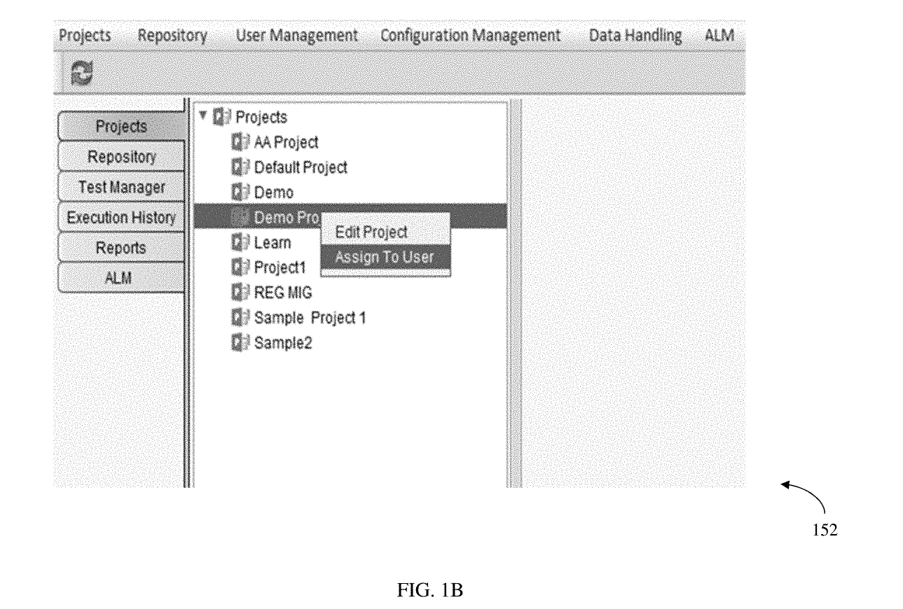

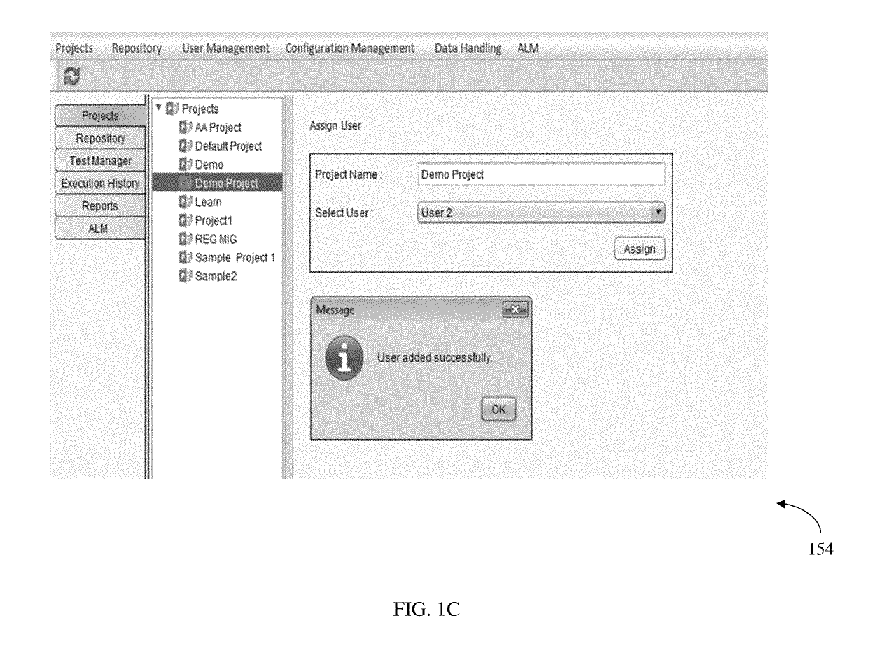

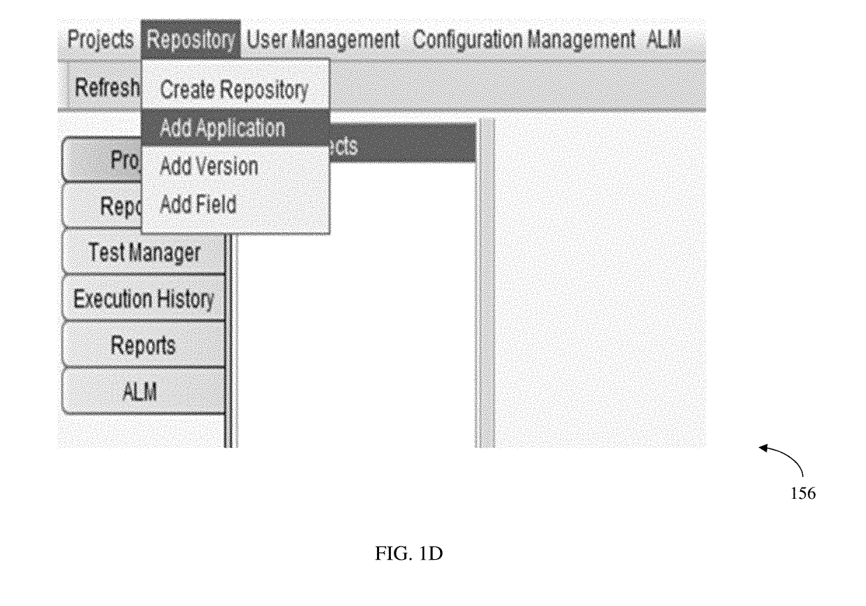

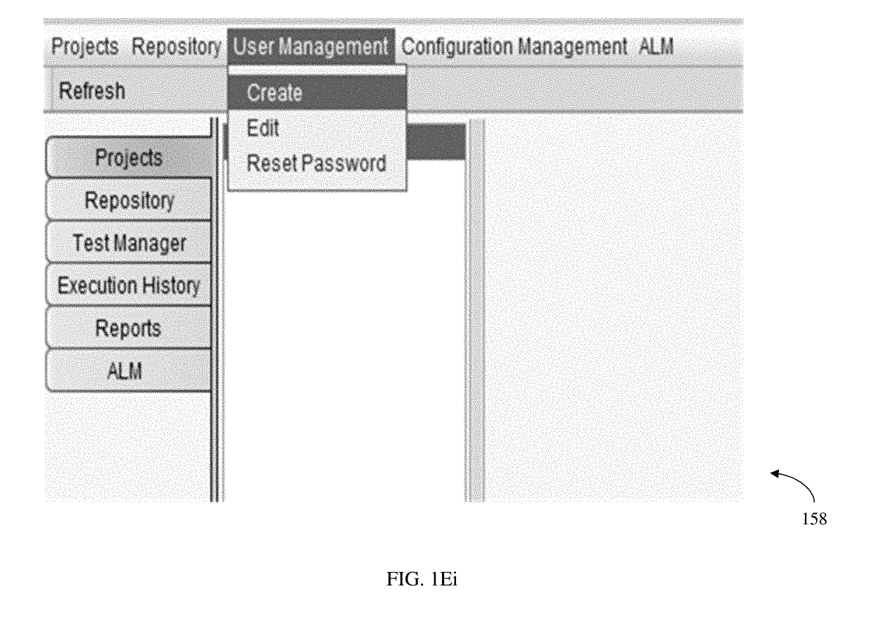

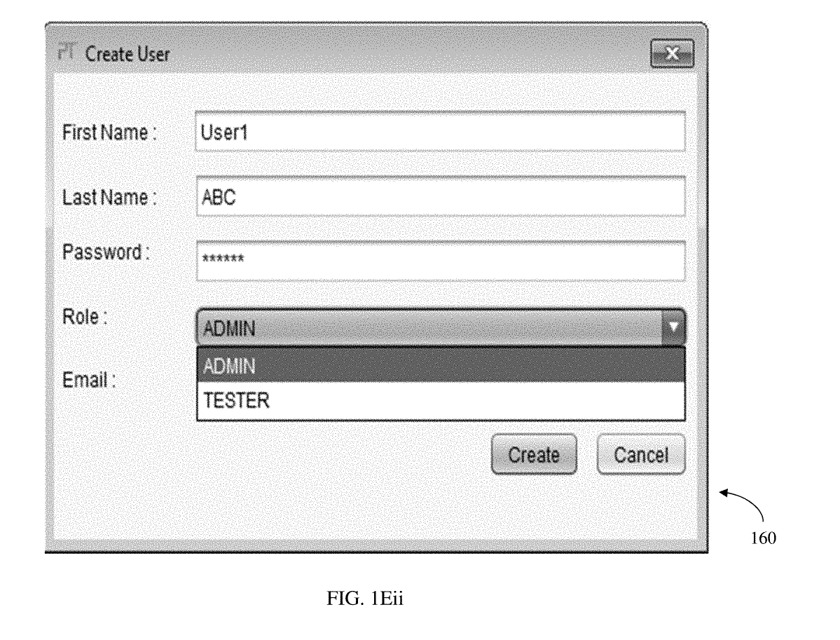

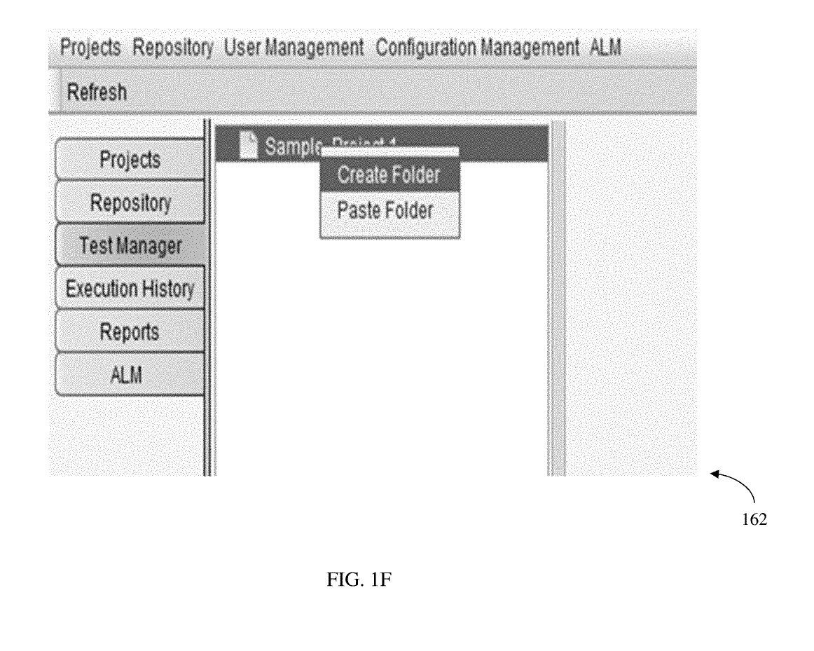

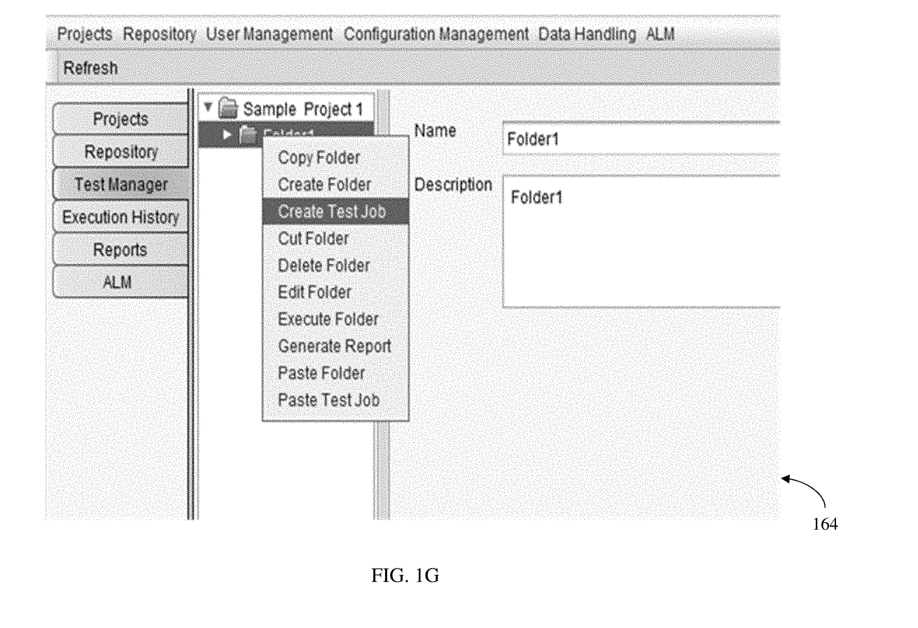

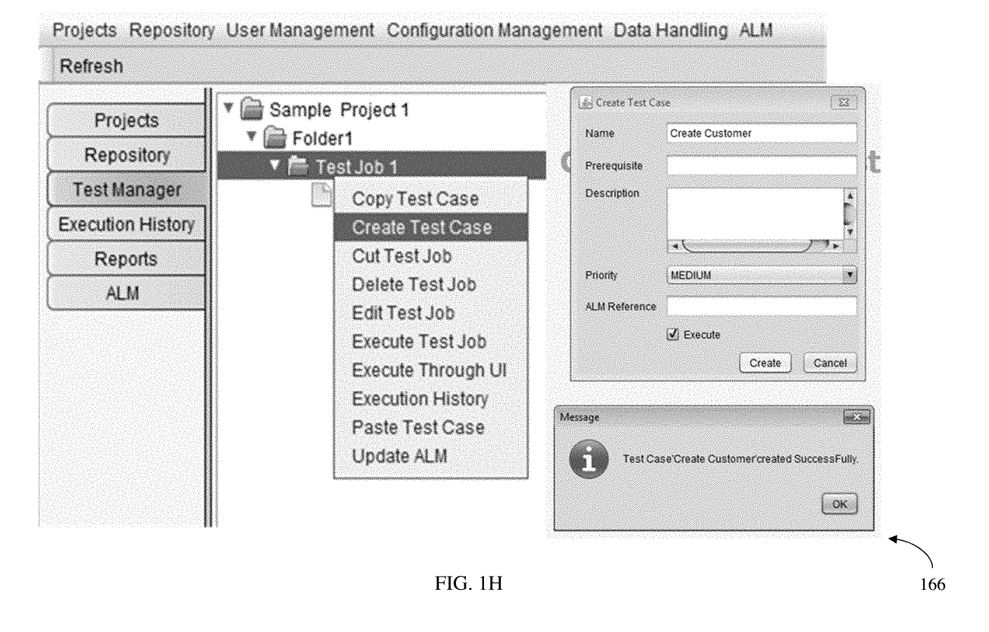

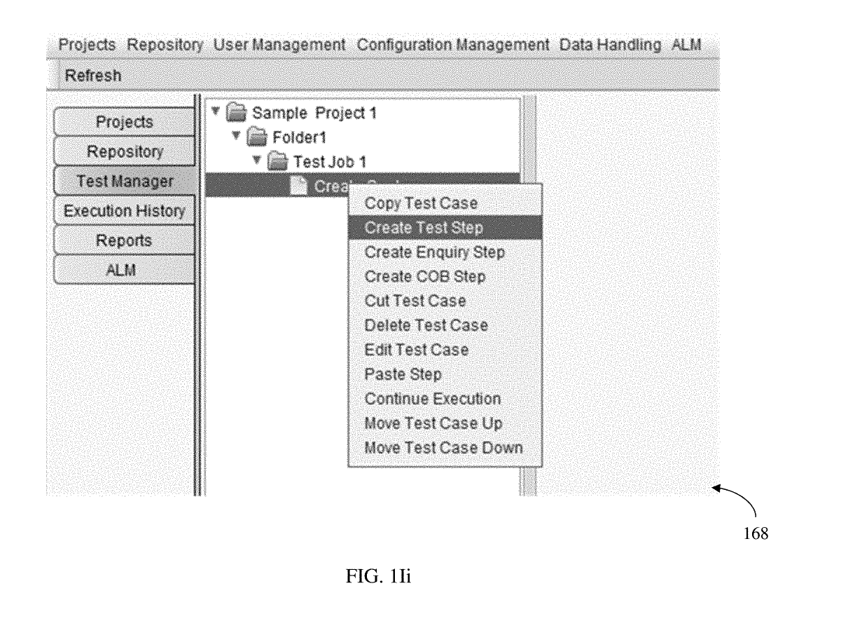

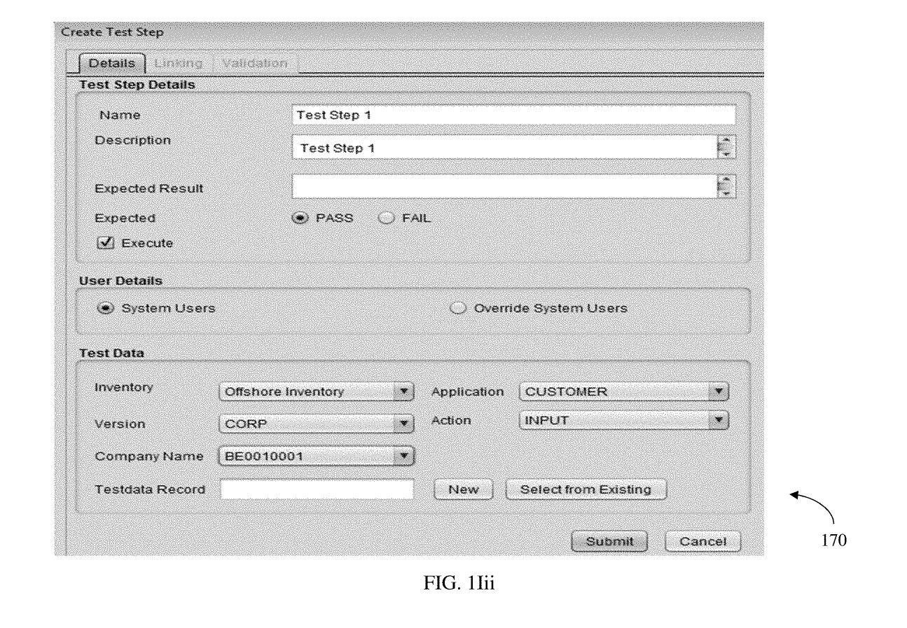

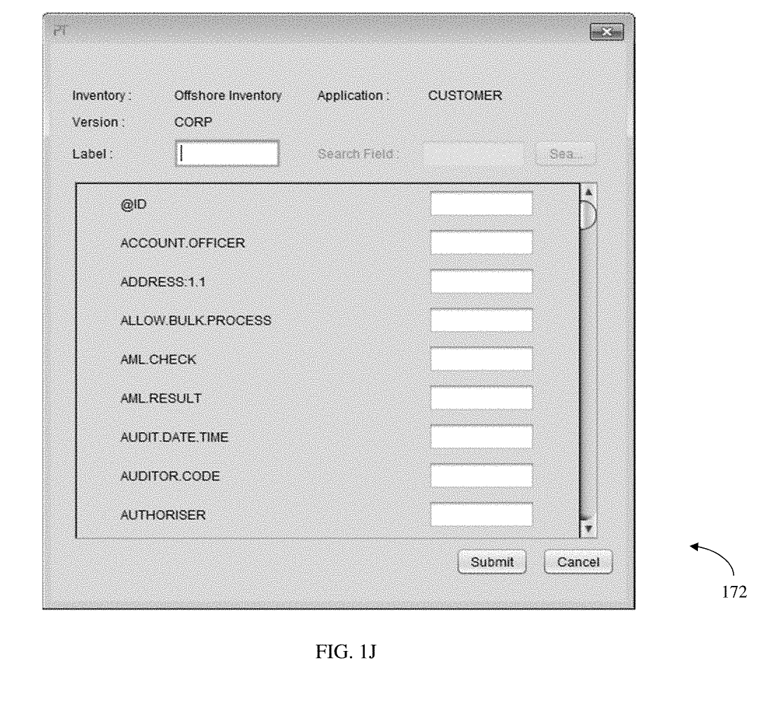

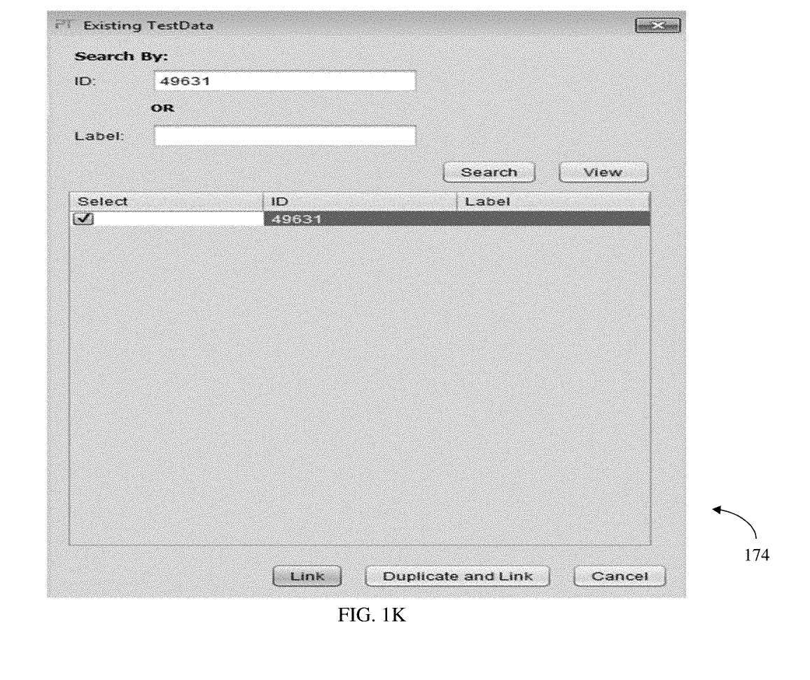

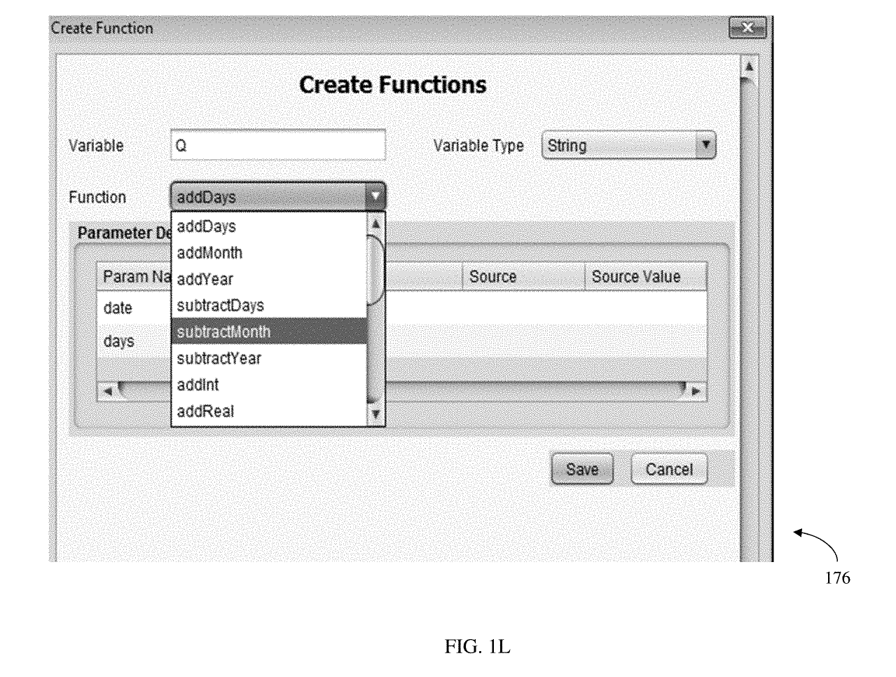

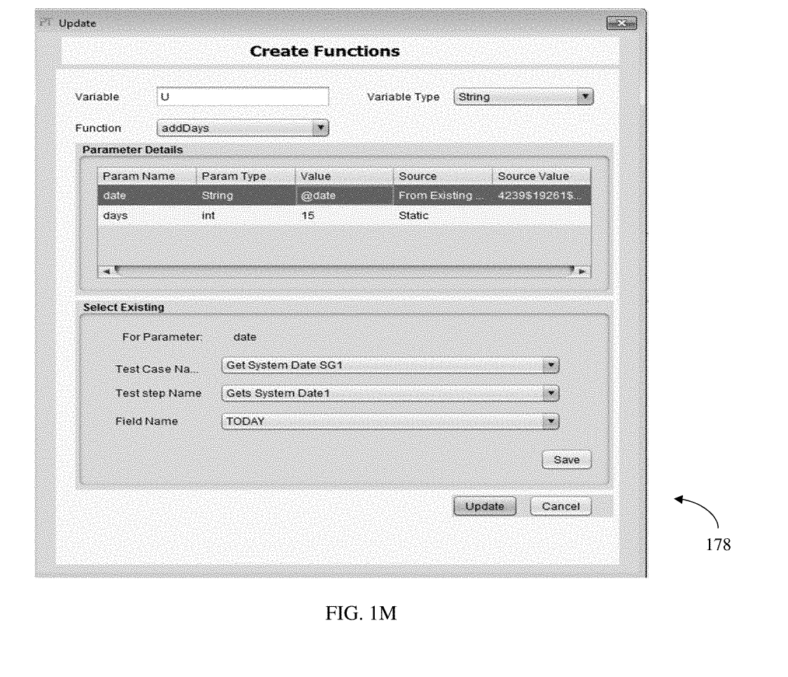

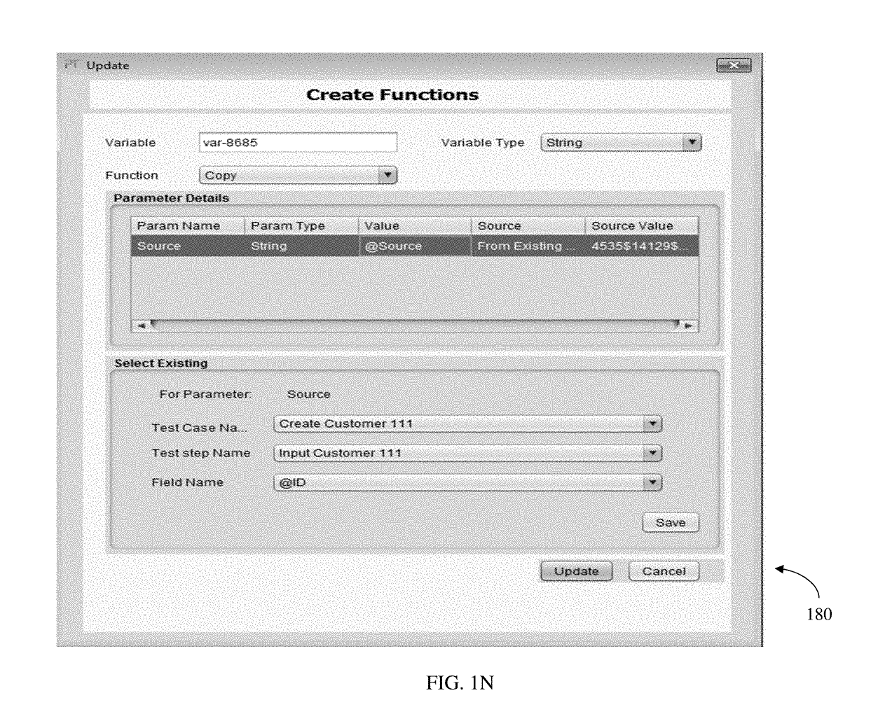

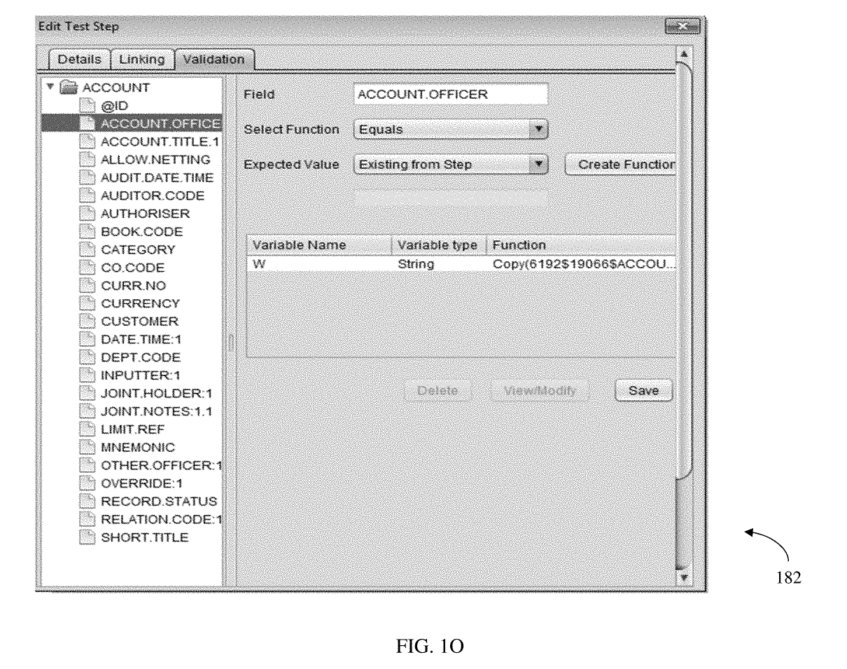

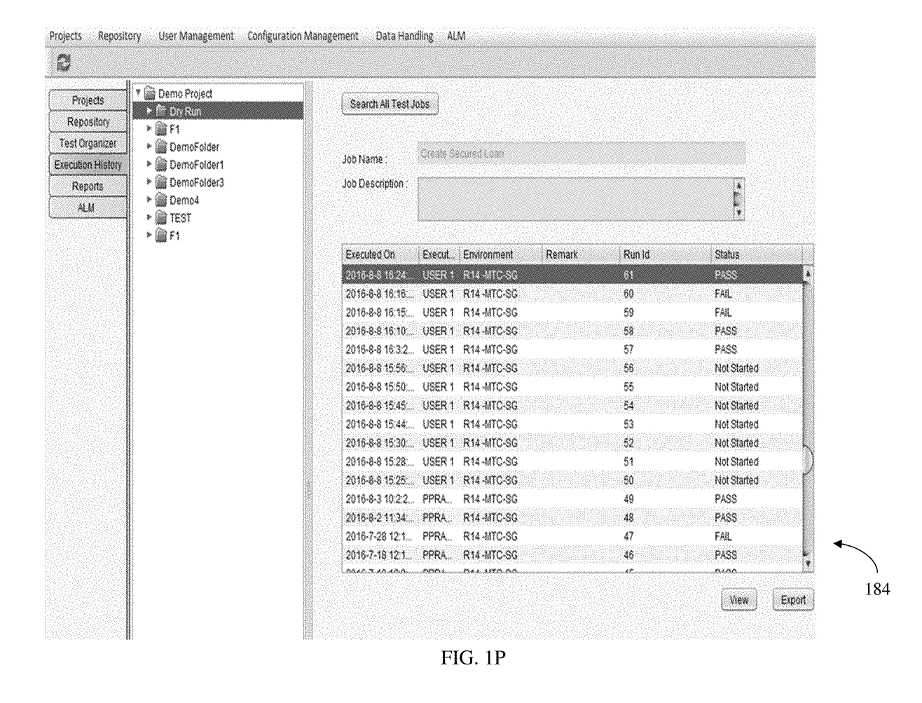

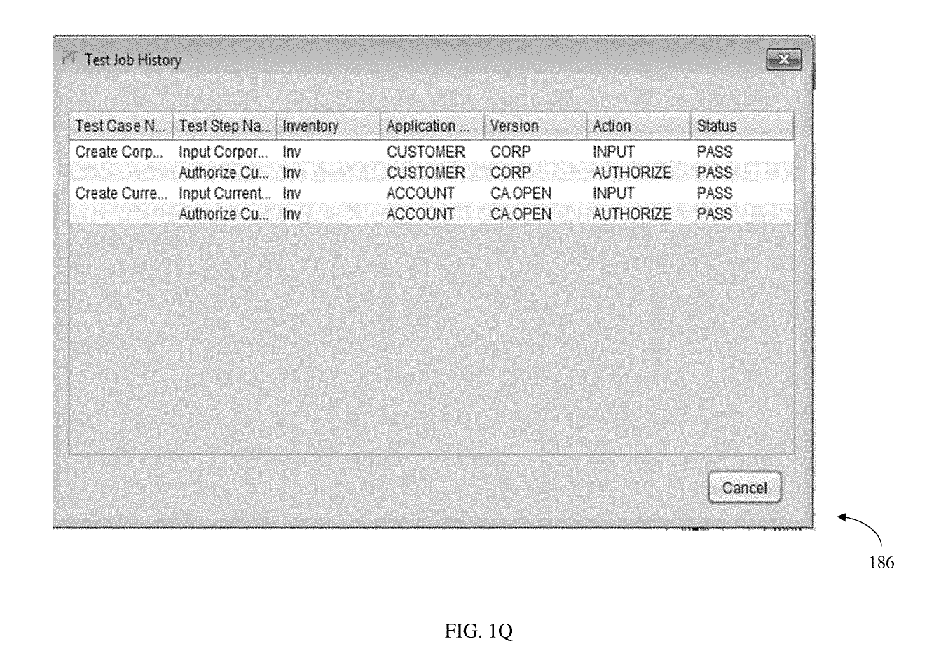

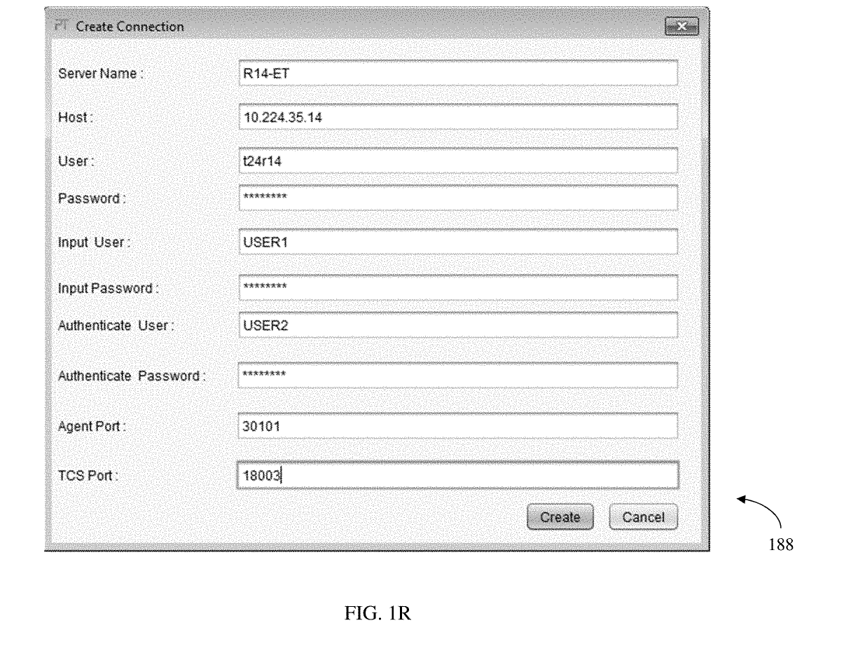

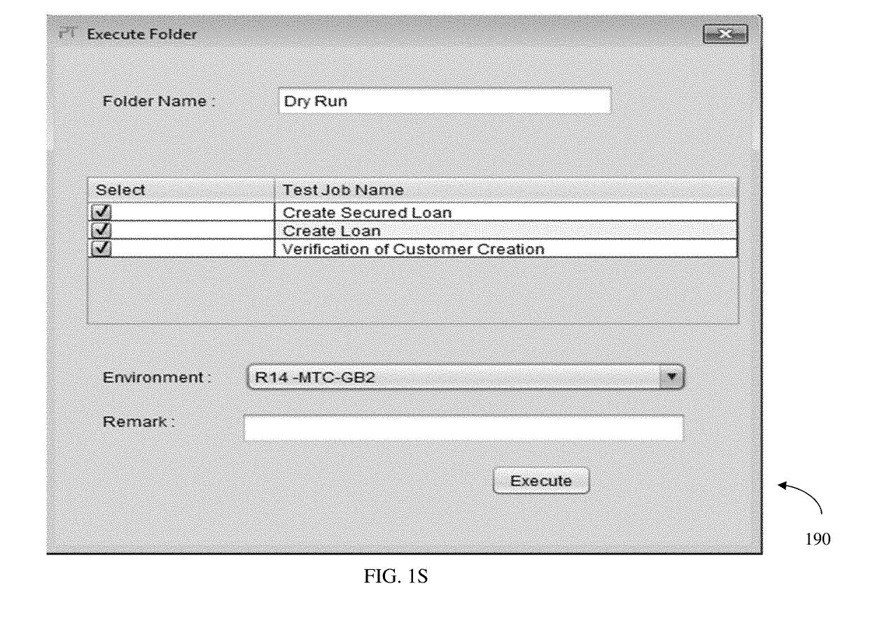

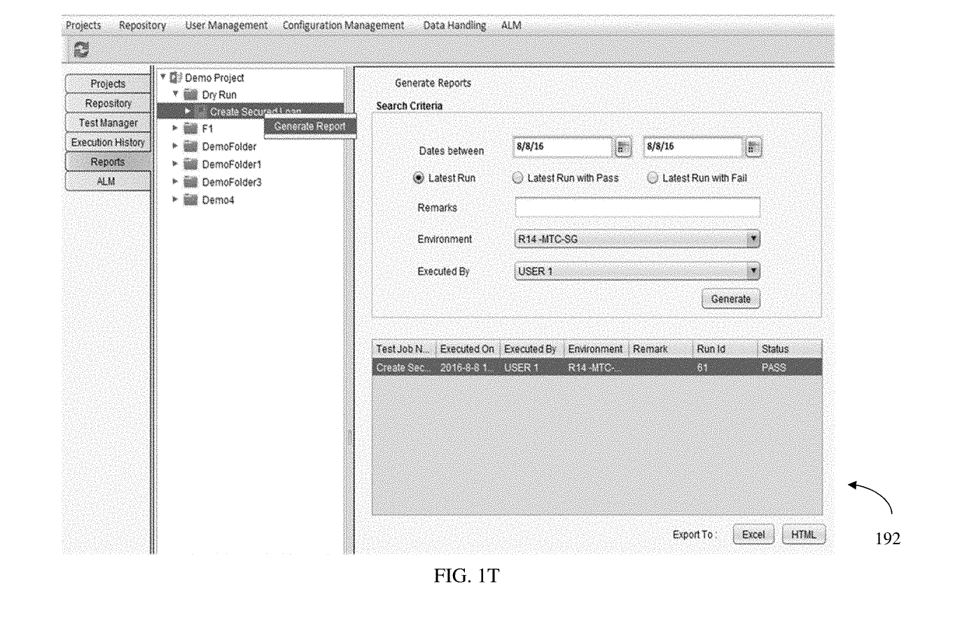

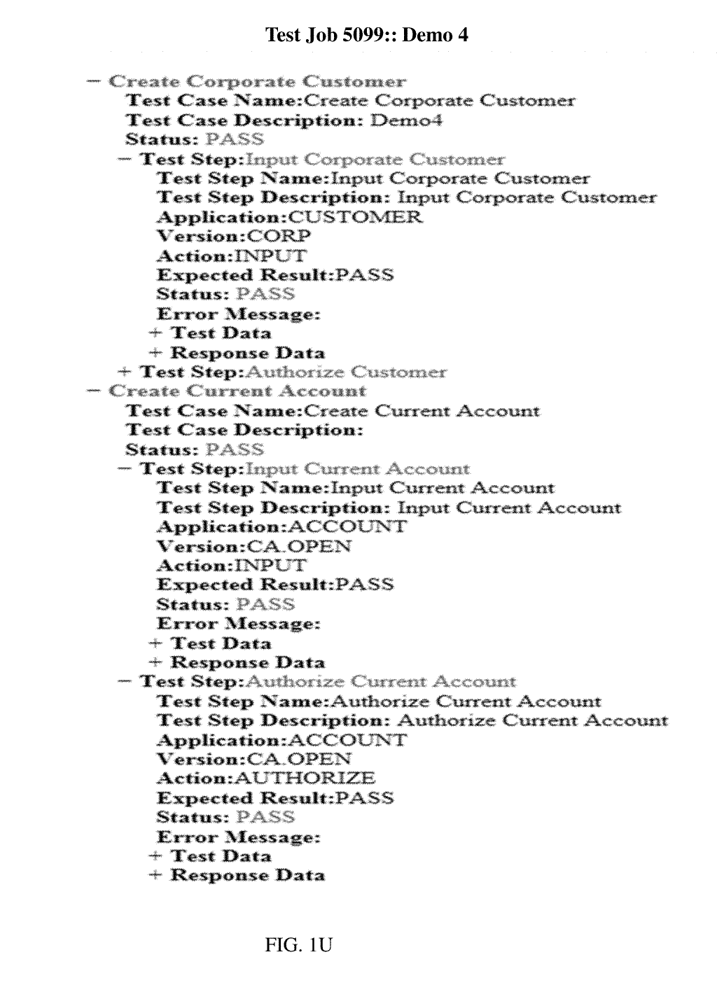

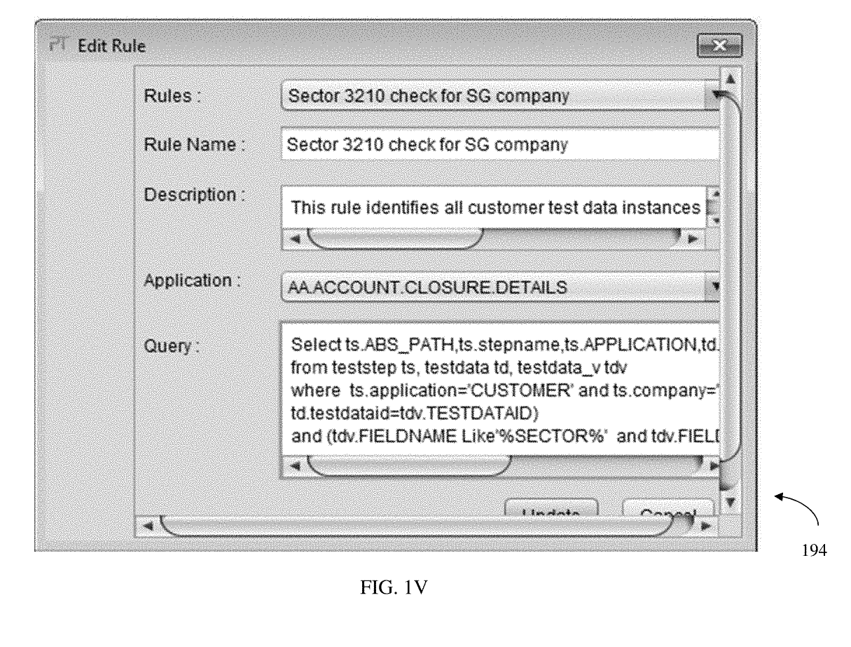

FIG. 1 is a block diagram illustrating a system 100 for generating and executing automated test cases, in accordance with an embodiment of the present invention. The system 100 comprises a testing unit 102, an electronic communication device 104, and an intermediary unit 106.

The testing unit 102 communicates with an enterprise system 108 via the intermediary unit 106. The enterprise system 108 is a target product for which one or more test cases are generated and executed, in accordance with various embodiments of the present invention. The enterprise system 108 comprise, but not limited to, user interfaces, Application Programming Interfaces (APIs) and applications to be tested. In an exemplary embodiment of the present invention, the enterprise system 108 is a core banking product. In an exemplary embodiment of the present invention, the intermediary unit 106 is an Open Financial Services (OFS) layer which provides an interface between the testing unit 102 and the enterprise system 108. In an embodiment of the present invention, the intermediary unit 106 facilitates interaction with the enterprise system 108 for accessing the applications to be tested. In another embodiment of the present invention, the one or more test cases are executed automatically via the intermediary unit 106 and one or more users/testers need not invoke screens and input values manually thereby increasing speed of test execution. Further, the intermediary unit 106 facilitates invoking the enterprise system 108 by converting information required for testing into one or more message formats that are compatible with the enterprise system 108.

In an embodiment of the present invention, the testing unit comprise a connector (not shown) which facilitates interfacing the testing unit with the intermediary unit 106. Further, the connector captures and queues the outgoing data from the testing unit 102 for the intermediary unit 106. The connector also captures the response from the intermediary unit 106 and routes the captured response to the testing unit 102. In an embodiment of the present invention, the connector resides within the testing unit 102 as a separate module. In another embodiment of the present invention, the connector resides outside the testing unit 102.

The testing unit 102 facilitates generating and executing automated test cases for testing functionalities of one or more applications of the enterprise system 108. In various embodiments of the present invention, the testing unit 102 provides one or more options for generating and executing test cases via the electronic communication device 104 of the one or more users. The electronic communication device 104 includes, but not limited to, laptops, desktops and handheld devices such as tablets and mobile phones. Although, FIG. 1 depicts only one electronic communication device 104, it may be obvious to a person of skill in the art that the testing unit 102 may be accessed via a plurality of electronic communication devices 104 simultaneously. The one or more options provided by the testing unit 102, via a user interface, facilitate in providing parametric details for creation, execution, and generation of reports of automated test cases. The one or more parametric details comprise information related to, but not limited to, testing project, application, test steps, priority and execution. In an embodiment of the present invention, the one or more options facilitate the one or more users to create testing projects, manage and configure applications, manage authorized users, link test data and execute test cases. Further, managing and configuring the one or more applications comprise importing data corresponding to the one or more applications from the enterprise system 108. Furthermore, the imported data facilitates the one or more users in efficiently creating the one or more test cases for automated execution.

In an exemplary embodiment of the present invention, the user interface provides one or more options including, but not limited to, projects, repository, user management, configuration management, application lifecycle management (ALM), test manager, execution history, and reports to the one or more users as depicted in FIG. 1A. In an embodiment of the present invention, the project option provided via the user interface 150 illustrated in FIG. 1A facilitates in categorizing the test cases and the test data based on a specific project. Further, specific users are assigned to a project by an administrator in order to keep the data secure. FIG. 1A, 1B and 1C illustrate an exemplary user interface to create new projects and add one or more users to the created projects, in accordance with an embodiment of the present invention.

In an exemplary embodiment of the present invention, the ‘projects’ option provided at the user interface 150 facilitates in creating testing projects. The ‘repository’ option facilitates management of applications for testing. The ‘repository’ option may further facilitate the users to configure a repository, import a new application or existing applications, their corresponding versions and metadata from the enterprise system 108 and configure and manage name, description, expected result, and test data details of the applications for testing. The applications facilitate in performing functions/operations related to the enterprise system 108. FIG. 1D illustrate a user interface for adding new applications and corresponding versions or fields to the testing unit 102, in accordance with an exemplary embodiment of the present invention.

FIG. 1Ei illustrate a user interface for creating a new user profile and editing existing user profiles, in accordance with an exemplary embodiment of the present invention. The “user management” option is used for creating new user profiles, editing existing profiles and resetting password for existing users via the user interface 158 depicted in FIG. 1Ei.

FIG. 1Eii illustrates a user interface 160 for creating a new user and selecting role of the new user, in accordance with an exemplary embodiment of the present invention. The one or more users are granted rights to access the testing unit 102 via the user interface 160. Further, the one or more users are provided access to selective functionalities of the testing unit 102 based on role assigned via the user interface 160.

FIG. 1F is a user interface illustrating ‘test manager’ tab used for creating a folder for new project, in accordance with an exemplary embodiment of the present invention. The ‘test manager’ option provided via the user interface 162 facilitates in generating test scripts, linking the test data, and executing test cases at the testing unit 102. In an embodiment of the present invention, for creating a new project, the user clicks on “create project” option. The user can then segregate and store the test cases and test data pertaining to the created project by creating multiple folders within the created project. The user may also re-name the created project and folders within the created project. Further, each folder comprise multiple test jobs pertaining to a specific functionality, company or any suitable criteria based on business requirement. Furthermore, each test job contain multiple test cases. In addition, each test case comprise multiple test steps. The test steps further comprise the test data. The test data is used for executing the test steps. In an embodiment of the present invention, the test data corresponding to a test step comprise variable values, static values and text. In an embodiment of the present invention, the test data corresponding to the test steps is pre-stored. In another embodiment of the present invention, the test data corresponding to the test steps is provided by the one or more users and linked to the one or more test steps. The test steps corresponding to a test case are performed for a desired functional output using the corresponding test data. For example, to create a customer in the enterprise system 108 of a bank, a banker will perform multiple actions wherein each action is considered as a test step. The test case is creation of the customer in the enterprise system comprising a set of multiple test steps. FIGS. 1G-1N provide a detailed description of various functions of the “test manager” option.

FIG. 1G is a user interface illustrating a “create test job” function, in accordance with an exemplary embodiment of the present invention. The “create test job” function facilitates in creating test jobs at the testing unit 102. By clicking on the “create test job” function, the user accessing the user interface 164 is prompted to provide details for creating test jobs. In an exemplary embodiment of the present invention, the “create test job” option may require name and description of the test job. FIG. 1H illustrates a user interface for creating a new test case, in accordance with an exemplary embodiment of the present invention. The “create test case” option provided by the test manager via the user interface 166 facilitates in creating test cases at the testing unit 102 (FIG. 1). By clicking on the “create test case” option, the user accessing the user interface 166 is prompted to provide details for creating the one or more test cases. In an exemplary embodiment of the present invention, the “Create Test Case” option prompts the one or more users to provide details such as, but not limited to, name, prerequisites, description, priority and Application Lifecycle Management (ALM) reference of corresponding test case. The prerequisite and the priority are provided by the one or more users based on the corresponding test case which is being created. In an exemplary embodiment of the present invention, the creation of a customer profile in a core banking enterprise system 108 may not require any prerequisite, while a prerequisite may be required for creation of an account. In another exemplary embodiment of the present invention, the priority field may provide HIGH, MEDIUM, and LOW as three options for selection during test case generation. In an exemplary embodiment of the present invention, if the checkbox provided at the bottom of the “create test case” tab in the screenshot is checked then the test case is executed during execution. If the checkbox is unchecked then the test case is not executed during execution.

FIG. 1Ii illustrates a user interface 168 depicting a “create test step” option for creating test steps via the testing unit 102, in accordance with an embodiment of the present invention. By clicking on the “create test step” option, the user accessing the user interface 168 is prompted to provide details for creating test steps and providing the test data corresponding to the created one or more test cases.

FIG. 1Iii illustrates a user interface 170 for providing details corresponding to a new test step, in accordance with an exemplary embodiment of the present invention. The ‘Create Test Step’ option prompts the user to enter details such as, but not limited to, Name, Description and Expected result. The checkbox for ‘Execute’ option if checked by the user facilitates in selecting the created test step during execution and if unchecked, then the test step is not executed during execution. Further, the Expected result may be selected as “PASS” or “FAIL” depending upon positive and negative test scenario respectively. In addition, the user may create a new test data record or link an existing test data record based on requirement. In an exemplary embodiment of the present invention, the test data section of the user interface 170 may include inventory, application, version, action, company name, and test data record fields. The inventory field may require appropriate repository resource name. The application field may require input related to one or more functions related to enterprise system 108. For example, the application may be ‘customer’ for a core banking enterprise system. The version field may specify the corresponding version related to the application to be tested. The action field may comprise of multiple options to be selected: INPUT, AUTHORIZE, DELETE, and REVERSE. The action field instructs the testing unit 102 to perform the specific act. In an embodiment of the present invention, the test data may be selected from an existing data record. In another embodiment of the present invention, new set of test data is provided as test data record.

FIG. 1J illustrates a user interface 172 for providing test data, in accordance with an exemplary embodiment of the present invention. In an embodiment of the present invention, the one or more users provide the test data in the test data fields illustrated in FIG. 1J. Further, while providing the test data, the one or more users may provide a ‘label’ of his choice instead of a system generated ID for future reference. In case multiple test steps are created using the same test data, the user need not create multiple labels and instead use pre-stored labels created earlier. FIG. 1K illustrates an exemplary user interface 174 for linking existing test data to a new test step, in accordance with an embodiment of the present invention. In an embodiment of the present invention, “test data ID” or “label of record” is used for searching existing test data. Further, the “link” button is used to link the existing test data to a new test step. In an embodiment of the present invention, for scenarios where majority of test data is same then the user can select the “duplicate and link” button which creates a copy of the test data corresponding to the test data ID provided via the user interface 174 and links it with the new test step. Further, the created copy has same test data but a different and new test data ID. The new copy of the test data having a different and new test data ID can then be modified as per user requirement.

FIG. 1L illustrates an exemplary user interface 176 provided by the testing unit 102 for creating functions, in accordance with an embodiment of the present invention. In an embodiment of the present invention, the ‘create function’ facilitates in providing variables as the test data which is used for executing specific test steps. Further, the provided variables are stored for further use with respect to the specific test steps. In an exemplary embodiment of the present invention, while creating a test step, the user may need to input details of entities created earlier, static values or a combination of both as the test data. FIG. 1M illustrates a user interface for setting static values for an ‘addDays’ function, in accordance with an exemplary embodiment of the present invention. The “addDays” function is used to link the test data using static values and existing entities. For example, the maturity date of a loan can be set using the addDays' function. FIG. 1N illustrates a user interface for configuring variables for account creation using a “copy” function, in accordance with an exemplary embodiment of the present invention. The “copy” function facilitates in providing the test data from existing entities. For example customer ID can be copied from existing entities while executing a test case for customer creation. FIG. 1O illustrates a user interface depicting a validation function, in accordance with an exemplary embodiment of the present invention. In an embodiment of the present invention, the validation function facilitates the one or more users to check execution. For example, as depicted in FIG. 1O the validation function checks if the

“ACCOUNT. OFFICER” field in the account is same as the account officer as per the customer details. Further, if the validation fails then the test step is considered failed. The testing unit 102 thus provide functional validation to ensure that generated test results are validated against expected results. The testing unit 102 provides inbuilt facility to introduce such check points in test script.

FIG. 1P illustrates a user interface depicting “execution history” option, in accordance with an exemplary embodiment of the present invention. The ‘execution history’ option provided at the user interface 184 facilitates in reviewing the history of executed test cases. FIG. 1P is discussed in detail in later sections of the specification. FIG. 1Q illustrates a user interface 186 depicting status of all test steps in a specific run from “execution history”, in accordance with an exemplary embodiment of the present invention.

FIG. 1R illustrates a user interface 188 depicting a configuration management option for facilitating access to an enterprise system, in accordance with an exemplary embodiment of the present invention. In an embodiment of the present invention, “User” and “Password” fields depicted in FIG. 1R are used for entering the authentication details for accessing the enterprise system 108. Further, “Input User”, “Input Password”, “Authenticate User” and “Authenticate Password” fields are used to access the enterprise application. Furthermore, “Agent Port” field facilitates in importing the metadata from the enterprise system 108 and “TCS Port” field facilitates in carrying service messages from the testing unit 102 via the intermediary unit 106 to the enterprise system 108.

In various embodiments of the present invention, the testing unit 102 comprises a configuration unit 110, an execution unit 112, a reporting unit 114, a parser 116 and a repository 118.

The configuration unit 110 is configured to create the one or more test cases based on input received from the one or more users via the user interface displayed on the electronic communication device 104. Further, the configuration unit 110 facilitates linking the created test case and corresponding test data (via the user interface) with one or more test scripts. The one or more test scripts are one or more functions, which on execution facilitate performing one or more actions associated with the one or more test cases to test specific functionality of the one or more applications under test. Further, the one or more functions use the test data corresponding to the one or more test cases as input during execution to generate output which is then validated against expected result. In an embodiment of the present invention, the one or more test scripts are stored in the repository 118. The repository 118 is also configured to store the metadata corresponding to the enterprise system 108 under test. The metadata comprise, but not limited to, the one or more enterprise applications and version and field details of the one or more enterprise applications related to the enterprise system 108 under test. In an exemplary embodiment of the present invention, the metadata may comprise version and field details of an application for creating customer accounts for an enterprise system of a bank. In an embodiment of the present invention, the configuration unit 110 is configured to receive test data and the corresponding one or more created test cases and version details of the enterprise system 108 and link the received test data and the corresponding one or more created test cases to a specific function/test script stored in the repository 118, thereby generating test cases for automated execution. The configuration unit 110 further stores each of the one or more created test cases along with a unique test case ID in the repository 118 for execution. The parser 116 is configured to convert the information required for testing into one or more message formats that are compatible with the enterprise system 108 and response from the enterprise system 108 to a format compatible with the testing unit 102 and a user understandable format. In an embodiment of the present invention, the parser 116 performs the conversion on receiving a request from the intermediary unit 106 during execution of the one or more test cases.

In an embodiment of the present invention, the execution unit 112 is configured to facilitate execution of the one or more created test cases corresponding to a test job at the enterprise system 108. In various embodiments of the present invention, the execution unit 112 is accessible via the user interface of the electronic communication device 104. The execution unit 112 provides one or more options related to execution for selection by the one or more users at the electronic communication device 104. In an exemplary embodiment of the present invention, the one or more options related to execution include, but not limited to, options for selection of environment (e.g. the enterprise system 108) for execution of the one or more created test cases. Further, the execution unit 112 is in communication with the enterprise system 108 via the intermediary unit 106.

FIG. 1S illustrates a user interface 190 depicting an “execute folder” option, in accordance with an exemplary embodiment of the present invention. The “execute” option is provided at the user interface 190 for execution of the generated test cases. The “execute” function prompts the user to select the generated test jobs and the environment. The environment may correspond to the enterprise system 108. Upon selection of “execute” button at the user interface 190, the selected test job is executed. The selected environment is invoked by the intermediary unit 106 from the enterprise system 108 for automatic execution.

The reporting unit 114 is configured to generate one or more reports corresponding to the executed test cases by communicating with the execution unit 112. The generated reports may indicate whether the one or more test cases are executed successfully or not. In an embodiment of the present invention, the reporting unit 114 provides the generated reports to the one or more users via the user interface of the electronic communication device 104. FIG. 1P illustrates a user interface depicting “execution history” option, in accordance with an exemplary embodiment of the present invention. Once the test cases are executed, the one or more reports may be viewed using the “execution history” option provided at the user interface 184 of the testing unit 102 accessible via the electronic communication device 104. In an embodiment of the present invention, the execution history is depicted for a particular test job. The status field in the execution history indicates execution result for the test job. In an exemplary embodiment of the present invention, the status may be one of, but not limited to, pass, fail, not started and In-Progress. Further, the execution history includes, but not limited to, date and time of execution, name of tester, environment of execution, run ID and the status of each run of the test job. Furthermore, details and status of each test step may also be viewed by the one or more users using the “view” option. In addition, an “export” option provided by the execution unit 114 facilitates in forwarding the one or more reports to a desired location within the user's machine and via one or more communication channels such as, but not limited to, Electronic Mail (Email), facsimile, Short Messaging Service (SMS) and instant messengers.

FIG. 1T illustrates a user interface 192 for viewing test execution reports, in accordance with an exemplary embodiment of the present invention. On clicking the “Generate report” option, the user is prompted to enter details about test case execution such as, but not limited to, date of execution, execution environment and name of tester as illustrated in FIG. 1T. Further, on clicking “Generate” option, latest test execution results corresponding to the provided details are displayed. Furthermore, the details of the execution are displayed as reports in various formats such as, but not limited to, spreadsheet format and Hypertext Markup Language (HTML) format. FIG. 1U illustrates a test execution report in an HTML format, in accordance with an exemplary embodiment of the present invention. The HTML report contains details related to each test step such as, but not limited to, test data provided, response data received from the enterprise application and status of each test step.

In an embodiment of the present invention, the testing unit 102 facilitates test scripts verification by facilitating the one or more users to develop rules to identify any errors in the test scripts. FIG. 1V illustrates a user interface 194 for creating a rule for test script verification, in accordance with an exemplary embodiment of the present invention. For example, if a user wants to create multiple customers with sector code as 3210, once the scripting is completed and before the test execution is started, the user can check if there are any test data instances having sector code other than 3210 thereby ensuring that incorrect data is not used for testing.

In an embodiment of the present invention, the system 100 is used for regression testing to test impact of any changes/modifications to existing applications. The system 100 facilitates in using and executing pre-stored test cases created by the one or more users using the testing unit 102 for previous projects or for testing previous versions of an application. The system 100 facilitates in eliminating manual testing that requires immense efforts and time thereby facilitating efficient regression testing.

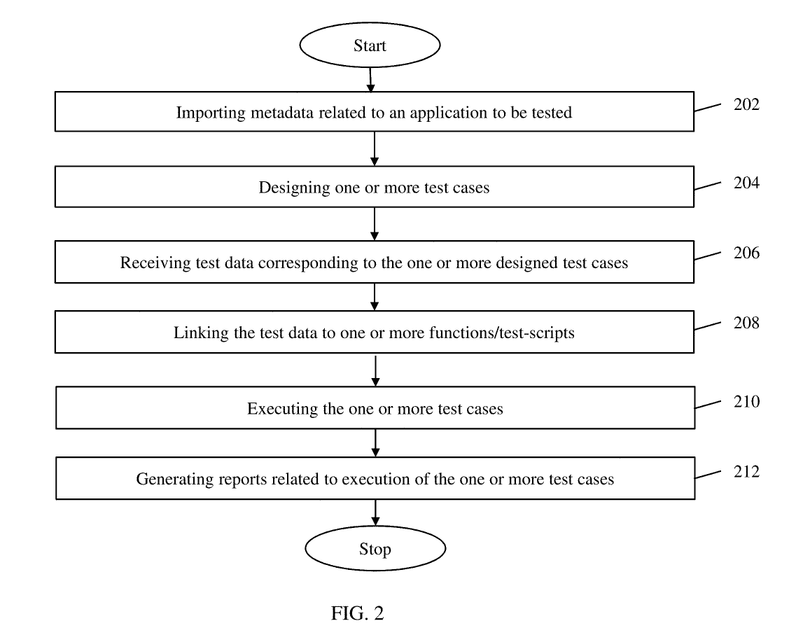

FIG. 2 illustrates a flowchart of a method for generating and executing automated test cases, in accordance with an embodiment of the present invention.

At step 202, metadata associated with one or more software application functionalities of an enterprise system is configured. In an exemplary embodiment of the present invention, the enterprise system may be a core banking product. The metadata includes, for example, data associated with a user interface application, application programming interfaces (APIs), or applications of the enterprise system to be tested. In another exemplary embodiment of the present invention, the metadata includes, but is not limited to, the one or more enterprise applications and version and field details of the one or more enterprise applications related to the enterprise system under test. In an embodiment of the present invention, the metadata is stored in a repository.

At step 204, one or more test cases are generated. In an embodiment of the present invention, one or more options for generation and execution of one or more test cases are provided at a user interface accessible to one or more users via one or more electronic communication device(s). The one or more options facilitate the one or more users to provide parametric details for creation, execution, and generation of reports corresponding to the one or more test cases. Further, the parametric details comprise information related to testing project, application, test steps, priority and execution. Furthermore, the one or more options provided at the user interface facilitate performing various operations such as, but not limited to, create testing projects, testing jobs and test cases, manage applications, manage authorized users, link test data to the created test cases and execute test cases. In an exemplary embodiment of the present invention, the one or more users provide details corresponding to the application to be tested such as, but not limited to, name, version and authentication details via the user interface.

At step 206, test data corresponding to the one or more generated test cases is received. Further, the received test data corresponding to the one or more test cases is used for execution of the one or more test cases. In an embodiment of the present invention, one or more options for receiving test data are provided at the user interface accessible to the one or more users. The provided test data is used for testing of the one or more applications associated with the enterprise system during execution of the one or more created test cases. In an exemplary embodiment of the present invention, for configuring a test step corresponding to the created one or more test cases, the one or more users provide test step details including, but not limited to, name, description, expected result and test data. The expected result is set to ‘PASS’ for positive test step and ‘FAIL’ for negative test step. In another exemplary embodiment of the present invention, the test data section at the user interface may include inventory, application, version, action, company name, and test data record fields. The inventory field may require appropriate repository resource. The application field may require input related to one or more functions related to enterprise system. For example, the application may be ‘customer’ for a core banking enterprise system. The version field may specify the corresponding version related to the enterprise system application to be tested. The action field may comprise of multiple options to be selected: INPUT, AUTHORIZE, DELETE, and REVERSE. The action field instructs the testing unit to perform the specific act. In an alternative embodiment of the present invention, the test data may be selected from an existing data record.

At step 208, the test data is linked to one or more test scripts. The one or more test scripts are one or more functions that on execution facilitate performing one or more actions related to the one or more test cases to test specific functionality of the application under test. In an embodiment of the present invention, the received test data may be linked to the appropriate version of a pre-stored test script, thereby generating automated test scripts for execution.

At step 210, the created one or more test cases are executed. In an embodiment of the present invention, one or more preferences are provided for selection at the user interface accessible to users via electronic communication device(s). The one or more preferences may correspond to selection of environment (i.e. enterprise system) for execution of test cases. In an embodiment of the present invention, the one or more test cases are executed by invoking the enterprise system comprising an application to be tested and executing the linked test scripts for testing the application. Further, the enterprise system is invoked automatically via an intermediary unit. Furthermore, the enterprise system is invoked by converting information required for testing into one or more message formats that are compatible with the enterprise system.

At step 212, one or more reports corresponding to the one or more executed test cases are generated. The generated reports may indicate whether a test case is executed successfully or not. In an embodiment of the present invention, the reporting unit provides the generated reports at a user interface of an electronic communication device accessible to the one or more users. In an embodiment of the present invention, the one or more reports corresponding to the executed one or more test cases are forwarded to a desired location via one or more communication channels. Further, the one or more communication channels comprise Electronic Mail (Email), facsimile, Short Messaging Service (SMS) and instant messengers.

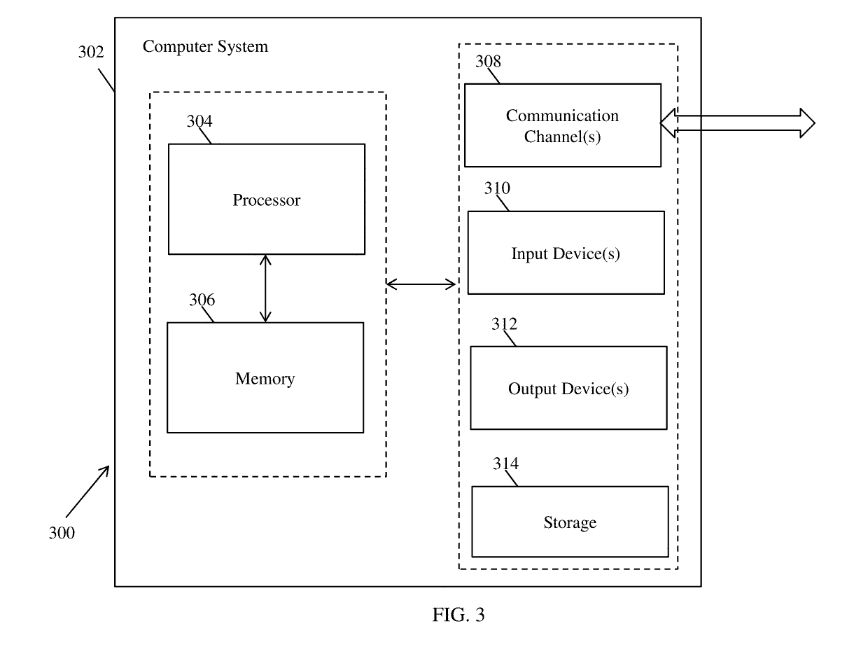

FIG. 3 illustrates an exemplary computer system for generating and executing test cases, in accordance with an embodiment of the present invention

The computer system 302 comprises a processor 304 and a memory 306. The processor 304 executes program instructions and may be a real processor. The processor 304 may also be a virtual processor. The computer system 302 is not intended to suggest any limitation as to scope of use or functionality of described embodiments. For example, the computer system 302 may include, but not limited to, a programmed microprocessor, a micro-controller, a peripheral integrated circuit element, and other devices or arrangements of devices that are capable of implementing the steps that constitute the method of the present invention. In an embodiment of the present invention, the memory 306 may store software for implementing various embodiments of the present invention. The computer system 302 may have additional components. For example, the computer system 302 includes one or more communication channels 308, one or more input devices 310, one or more output devices 312, and storage 314. An interconnection mechanism (not shown) such as a bus, controller, or network, interconnects the components of the computer system 302. In various embodiments of the present invention, operating system software (not shown) provides an operating environment for various softwares executing in the computer system 302, and manages different functionalities of the components of the computer system 302.

The communication channel(s) 308 allow communication over a communication medium to various other computing entities. The communication medium provides information such as program instructions, or other data in a communication media. The communication media includes, but not limited to, wired or wireless methodologies implemented with an electrical, optical, RF, infrared, acoustic, microwave, bluetooth or other transmission media.

The input device(s) 310 may include, but not limited to, a keyboard, mouse, pen, joystick, trackball, a voice device, a scanning device, or any another device that is capable of providing input to the computer system 302. In an embodiment of the present invention, the input device(s) 310 may be a sound card or similar device that accepts audio input in analog or digital form. The output device(s) 312 may include, but not limited to, a user interface on CRT or LCD, printer, speaker, CD/DVD writer, or any other device that provides output from the computer system 302.

The storage 314 may include, but not limited to, magnetic disks, magnetic tapes, CD-ROMs, CD-RWs, DVDs, flash drives or any other medium which can be used to store information and can be accessed by the computer system 302. In various embodiments of the present invention, the storage 314 contains program instructions for implementing the described embodiments.

The present invention may suitably be embodied as a computer program product for use with the computer system 302. The method described herein is typically implemented as a computer program product, comprising a set of program instructions which is executed by the computer system 302 or any other similar device. The set of program instructions may be a series of computer readable codes stored on a tangible medium, such as a computer readable storage medium (storage 314), for example, diskette, CD-ROM, ROM, flash drives or hard disk, or transmittable to the computer system 302, via a modem or other interface device, over either a tangible medium, including but not limited to optical or analogue communications channel(s) 308. The implementation of the invention as a computer program product may be in an intangible form using wireless techniques, including but not limited to microwave, infrared, bluetooth or other transmission techniques. These instructions can be preloaded into a system or recorded on a storage medium such as a CD-ROM, or made available for downloading over a network such as the internet or a mobile telephone network. The series of computer readable instructions may embody all or part of the functionality previously described herein.

The present invention may be implemented in numerous ways including as an apparatus, method, or a computer program product such as a computer readable storage medium or a computer network wherein programming instructions are communicated from a remote location.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims.

We claim:

1. A system for generating and executing test cases, the system comprising:
a configuration unit configured to:
receive test data corresponding to one or more test cases; and
link the received test data to one or more test scripts;
an execution unit configured to execute the one or more test cases by invoking an enterprise system comprising an application to be tested and executing the linked test scripts for testing the application, wherein the enterprise system is invoked automatically via an intermediary unit; and
a reporting module configured to generate one or more reports corresponding to the executed one or more test cases.

2. The system of claim 1, wherein the one or more test cases are created by providing parametric details for creation, execution, and generation of reports corresponding to the one or more test cases.

3. The system of claim 2, wherein the parametric details comprise information related to testing project, application, test steps, priority and execution.

4. The system of claim 1, wherein the received test data corresponding to the one or more test cases is used for execution of the one or more test cases.

5. The system of claim 1, wherein the one or more test scripts are one or more functions that on execution facilitate performing one or more actions related to the one or more test cases to test specific functionality of the application under test.

6. The system of claim 1, wherein the intermediary unit facilitates invoking the enterprise system by converting information required for testing into one or more message formats that are compatible with the enterprise system.

7. The system of claim 1, wherein the reporting module is further configured to facilitate forwarding the one or more reports to a desired location via one or more communication channels.

8. The system of claim 7, wherein the one or more communication channels comprise Electronic Mail (Email), facsimile, Short Messaging Service (SMS) and instant messengers.

9. A computer-implemented method for generating and executing test cases, via program instructions stored in a memory and executed by a processor, the computer-implemented method comprising:
receiving test data corresponding to one or more test cases;
linking the received test data to one or more test scripts;
executing the one or more test cases by invoking an enterprise system comprising an application to be tested and executing the linked test scripts for testing the application, wherein the enterprise system is invoked automatically via an intermediary unit; and
generating one or more reports corresponding to the executed one or more test cases.

10. The computer-implemented method of claim 9, wherein the one or more test cases are created by providing parametric details for creation, execution, and generation of reports corresponding to the one or more test cases.

11. The computer-implemented method of claim 10, wherein the parametric details comprise information related to testing project, application, test steps, priority and execution.

12. The computer-implemented method of claim 9, wherein the received test data corresponding to the one or more test cases is used for execution of the one or more test cases.

13. The computer-implemented method of claim 9, wherein the one or more test scripts are one or more functions that on execution facilitate performing one or more actions related to the one or more test cases to test specific functionality of the application under test.

14. The computer-implemented method of claim 9, wherein the enterprise system is invoked by converting information required for testing into one or more message formats that are compatible with the enterprise system.

15. The computer-implemented method of claim 9 further comprising the step of forwarding the one or more reports to a desired location via one or more communication channels.

16. The computer-implemented method of claim 15, wherein the one or more communication channels comprise Electronic Mail (Email), facsimile, Short Messaging Service (SMS) and instant messengers.

17. A computer program product for generating and executing test cases, the computer program product comprising:
a non-transitory computer-readable medium having computer-readable program code stored thereon, the computer-readable program code comprising instructions that when executed by a processor, cause the processor to:
receive test data corresponding to one or more test cases;
link the received test data to one or more test scripts;
execute the one or more test cases by invoking an enterprise system comprising an application to be tested and executing the linked test scripts for testing the application, wherein the enterprise system is invoked automatically via an intermediary unit; and
generate one or more reports corresponding to the executed one or more test cases.
